(19) United States
(12) Patent Application Publication
(10) Pub. No.: US 2013/0245925 A1
(43) Pub. Date: Sep. 19, 2013

(54) FEEDBACK SYSTEM FOR ENGINE AUTO STOP INHIBIT CONDITIONS

(71) Applicants: Mark Douglas Malone, Canton, MI (US); Scott R. Caudill, Saline, MI (US); William Najib Mansur, West Bloomfield, MI (US); Joseph Andrew Zamora, Ann Arbor, MI (US); Kirk Pebley, Novi, MI (US)

(72) Inventors: Mark Douglas Malone, Canton, MI (US); Scott R. Caudill, Saline, MI (US); William Najib Mansur, West Bloomfield, MI (US); Joseph Andrew Zamora, Ann Arbor, MI (US); Kirk Pebley, Novi, MI (US)

(73) Assignee: FORD GLOBAL TECHNOLOGIES, LLC, Dearborn, MI (US)

(21) Appl. No.: 13/423,368

(22) Filed: Mar. 19, 2012

(51) Int. Cl. F02D 28/00

(52) U.S. Cl. 701/113

(57) ABSTRACT

A vehicle includes an engine and a stop/start system that selectively auto stops and auto starts the engine, detects an auto stop inhibit condition that prevents the engine from being auto stopped, and in response, generates output based on the auto stop inhibit condition if the auto stop inhibit condition falls within a predetermined class of auto stop inhibit conditions. The vehicle also includes an interface that displays or plays the output to inform a driver of the vehicle about the detected auto stop inhibit condition.

### TECHNICAL FIELD

This disclosure relates to algorithms and systems implementing the same for providing feedback to operators of micro-hybrid or stop/start vehicles.

### BACKGROUND

A micro-hybrid or stop/start vehicle can selectively turn its engine off during portions of a drive cycle to conserve fuel. As an example, a stop/start vehicle can turn its engine off while the vehicle is stopped rather than allow the engine to idle. The engine can then be restarted, for example, when a driver steps on the accelerator pedal.

### SUMMARY

A vehicle includes an engine, a stop start system and an interface. The stop/start system includes one or more controllers that selectively auto stop the engine when a speed of the vehicle is approximately zero, detect an auto stop inhibit condition that prevents the engine from being auto stopped when the speed of the vehicle is approximately zero, and in response, generate output based on the auto stop inhibit condition if the auto stop inhibit condition falls within a predetermined class of auto stop inhibit conditions. The interface displays or plays the output to inform a driver of the vehicle about the detected auto stop inhibit condition.

A method for advising a driver of a vehicle including an engine and a stop/start system configured to selectively auto stop the engine when a speed of the vehicle is approximately zero includes detecting an auto stop inhibit condition that prevents the engine from being auto stopped when the speed of the vehicle is approximately zero, generating, in response, output based on the detected auto stop inhibit condition if the auto stop inhibit condition falls within a predetermined class of auto stop inhibit conditions, and displaying or playing the output to inform the driver about the detected auto stop inhibit condition.

A vehicle includes an engine and a stop/start system that selectively auto stops and auto starts the engine, detects an auto stop inhibit condition that prevents the engine from being auto stopped, and in response, generates output based on the auto stop inhibit condition if the auto stop inhibit condition falls within a predetermined class of auto stop inhibit conditions. The vehicle further includes an interface arranged to display or play the output.

The predetermined class of auto stop inhibit conditions can include climate system activated, entertainment system activated, steering wheel angle greater than threshold value, brake pedal disengaged, accelerator pedal engaged or power access point active. The output can be indicative of a number of auto stop inhibit conditions detected during a drive cycle. The output can be displayed via text or a graphical interface element.

### BRIEF DESCRIPTION OF THE DRAWINGS

FIG. 1 is a block diagram of an automotive vehicle.

FIG. 2 is a flow chart illustrating an algorithm for determining whether an engine auto stop was precluded because of operator discretionary action.

### DETAILED DESCRIPTION

Embodiments of the present disclosure are described herein; however, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As mentioned above, a micro-hybrid or stop/start vehicle can selectively turn off its engine during a drive cycle. These auto stop events typically take place while vehicle speed is approximately zero, e.g., while the vehicle is stopped at an intersection. Additional parameters, however, can be evaluated when determining whether to turn off the engine. These parameters can include battery voltage, system current demand, steering wheel angle, etc. The battery voltage and system current demand can be monitored in an attempt to maintain operating parameters associated with the battery, e.g., voltage and state of charge, within some desired range. Because the battery cannot be charged during an engine auto stop, its voltage and state of charge can drop to undesirable levels if current is drawn in large amounts or for extended periods of time. Steering wheel angle can be monitored to anticipate an imminent request for wheel torque. A driver who positions the steering wheel at some angle relative to center when coming to a stop is likely to only be stopped for a brief period of time. It may not be efficient to shut down the engine for such a brief period of time. Hence, the engine can remain on even though vehicle speed is zero if, for example, the battery voltage is less than some threshold value or the steering wheel angle is greater than some threshold value.

Values of some of the additional parameters, during certain times, can be substantially affected by operator choice to increase operator comfort or convenience. System current demand, as an example, depends on whether the air conditioning system has been activated or whether an accessory unit, such as a navigation system, has been plugged into a power access point. Values of some of the additional parameters, during other times, can be substantially affected by operator choice responsive to ambient conditions. System current demand, as an example, depends on whether the headlights have been activated. If ambient light levels are low, however, the operator may have no choice but to activate the headlights. System current demand, as another example, depends on whether the wiper system has been activated. If there is significant rain during the drive cycle, however, the operator may have no choice but to activate the wiper system. Values of some of the additional parameters, during still other times, can be substantially affected for reasons unrelated to operator choice. System current demand, as an example, can be indeterminate because of faulty network connections or other system issues.

An engine auto stop can thus be inhibited because of operator action to increase comfort or convenience, or for other reasons. Informing a driver of lost auto stop opportunities because of operator action to increase comfort or convenience can influence driver behavior and potentially decrease lost auto stop opportunities and increase fuel economy.

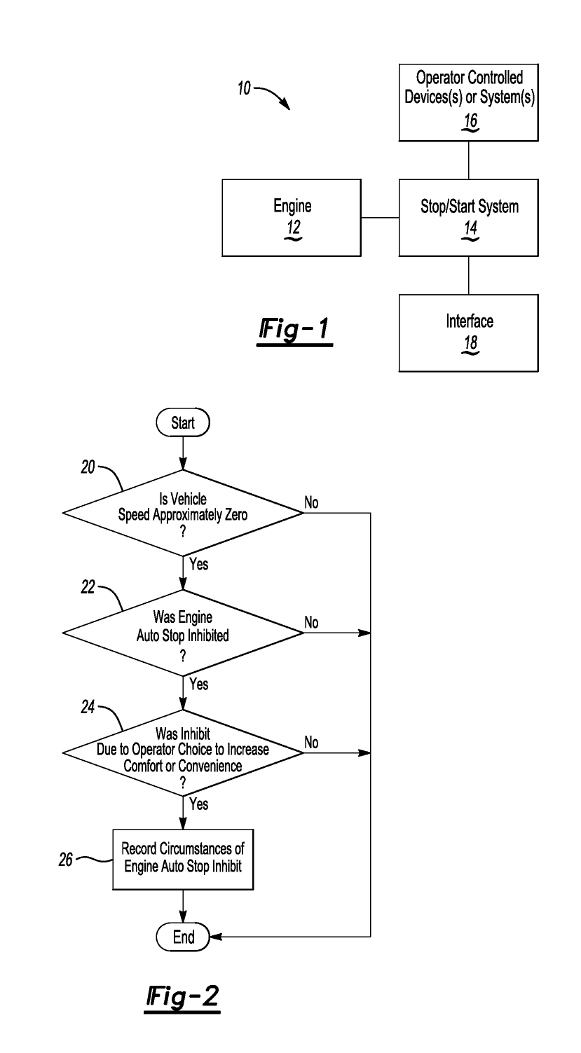

Referring to FIG. 1, a vehicle 10 includes an engine 12, a stop/start system 14 (e.g., one or more controllers, etc.), operator controlled devices or systems 16, and an interface 18. Examples of the operator controlled devices or systems 16 include steering wheel, brake pedal, accelerator pedal, wiper system, air conditioning system, heating system, power access point system, entertainment system (DVD player, etc.), headlight system, etc. The engine 12, operator controlled devices or systems 16, and the interface are in communication with and/or under the control of the controllers 14.

The engine 12 is arranged, as known in the art, to provide motive power for the vehicle 10. Moreover, the stop/start system 14 is arranged to shut down the engine 12 if a speed of the vehicle 10 is approximately zero provided that such auto stop attempts are not precluded by an inhibit condition. That is, an inhibit condition prevents the stop/start system 14 from shutting down the engine 12 even when the speed of the vehicle 10 is approximately zero. Hence if the engine 12 is running and the speed of the vehicle 10 is approximately zero, engine auto stop was precluded.

The operator controlled devices or systems 16 can include sensor arrangements that permit the stop/start system 14 to obtain information about them as known in the art. The steering wheel, for example, can have an associated sensor to collect steering wheel position data. The brake and accelerator pedals can have associated position sensors to collect pedal position data. The wiper system, air conditioning system, heating system, power access point system, entertainment system and headlight system can have associated sensors that detect whether these systems are active. As an example, an AC/DC inverter of the power access point system can be instrumented so that data about inverter activity, which implies that an accessory unit is electrically connected with the power access point system, is available to the stop/start system 14. Other arrangements are also contemplated.

The activation or positioning of the operator controlled devices or systems 16, as mentioned above, can affect values of parameters used to determine whether to preclude an auto stop of the engine 12. Moreover, certain system activations or device positions are implemented to increase customer comfort or convenience whereas others are implemented in response to ambient conditions. These activations or positions can then be categorized as either comfort/convenience related or ambient conditions related. Table 1 is an example of such a classification scheme:

TABLE 1
Categorization of Operator Controlled Devices and Systems

| Comfort/Convenience Related | Ambient Conditions Related |
|---|---|
| Entertainment System Active | Wiper System Active |
| Power Access Point System Active | Headlight System Active |
| Air Conditioning System Active | Steering Wheel Angle Greater |
| | Than Threshold |

The above categorization is of course just an example and not exhaustive. Testing, simulation, etc. can be performed to determine whether the activation or positioning of any operator controlled device or system is performed to improve comfort or convenience (discretionary in some sense), or performed in response to ambient conditions (non-discretionary).

Using this categorization information, the stop/start system 14 can implement algorithms to determine whether operator discretionary action reduced the probability of engine auto stop. Put another way, the controllers 14 can determine whether operator discretionary action negatively impacted fuel economy. As an example, if the stop/start system 14 observes a speed of the vehicle 10 to be approximately zero (by, for example, reading data from known wheel speed sensors), the engine 12 to be running (by, for example, reading data from known engine sensors), and the entertainment system 16 to be active (by, for example, detecting in a known fashion whether the DVD player is on), the stop/start system 14 can conclude that the additional current draw by the entertainment system 16 affected at least one of the parameters (e.g., battery voltage, battery current, etc.) evaluated when determining whether to auto stop the engine 12 so as to reduce the likelihood of engine auto stop. Similar rules can be constructed for other of the comfort/convenience related activating or positioning of the operator controlled devices or systems 16.

The circumstances associated with operator discretionary action that contributed to the auto stop inhibit condition can be recorded, tracked and/or reported to the operator. Continuing with the example above, data about the lost or reduced opportunity for engine auto stop because the entertainment system 16 was active can be stored, tracked and/or reported by the stop/start system 14. Information about such, for example, can be communicated to the operator via the interface 18. The interface 18, for example, can display a textual message that reads: “The engine could not be shut down because a convenience feature was active.” Alternatively, the interface 18 can display a graphical element such as an icon that decreases in size or otherwise changes (e.g., a tree losing its leaves, a circle getting smaller, etc.) as the number of lost or reduced opportunities for engine auto stop increases during a drive cycle. Other scenarios are also possible.

Referring to FIG. 2, it is determined whether vehicle speed is approximately zero at operation 20. For example, data from known wheel speed sensors or other suitable/known sensors can be read to determine whether vehicle speed is approximately zero. If no the algorithm ends. If yes, it is determined whether engine auto stop was inhibited at operation 22. For example, data from known engine sensors can be read to determine whether the engine is running If no, the algorithm ends. If yes, it is determined whether the auto stop inhibit was due to operator choice to increase comfort or convenience at operation 24. For example, data from known sensors associated with comfort/convenience systems such as entertainment system, power access point system, air conditioning system, etc. can be read to determine if any of these systems are active. If no, the algorithm ends. If yes, data regarding the circumstances contributing to the engine auto stop inhibit are recorded/reported at operation 26. For example, the types of comfort/convenience systems activated can be recorded, the number of auto stop inhibit conditions caused by comfort/convenience systems being activated during a drive cycle can be reported, etc.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the algorithms can be embodied in whole or in part using suitable hardware components, such as Application Specific Integrated Circuits (ASICs), Field-Programmable Gate Arrays (FPGAs), state machines, or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure and claims. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to, cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and could be desirable for particular applications.

What is claimed is:

1. A vehicle comprising:
an engine;
a stop/start system including one or more controllers configured to selectively auto stop the engine when a speed of the vehicle is approximately zero, to detect an auto stop inhibit condition that prevents the engine from being auto stopped when the speed of the vehicle is approximately zero, and in response, to generate output based on the auto stop inhibit condition if the auto stop inhibit condition falls within a predetermined class of auto stop inhibit conditions; and
an interface arranged to display or play the output to inform a driver of the vehicle about the auto stop inhibit condition.

2. The vehicle of claim 1 wherein the predetermined class of auto stop inhibit conditions includes climate system activated, entertainment system activated, steering wheel angle greater than threshold value, brake pedal disengaged, accelerator pedal engaged or power access point active.

3. The vehicle of claim 1 wherein the output is indicative of a number of auto stop inhibit conditions detected during a drive cycle.

4. The vehicle of claim 1 wherein the interface is configured to display the output via text.

5. The vehicle of claim 1 wherein the interface is configured to display the output via a graphical interface element.

6. A method for advising a driver of a vehicle including an engine and a stop/start system configured to selectively auto stop the engine when a speed of the vehicle is approximately zero, the method comprising:
detecting an auto stop inhibit condition that prevents the engine from being auto stopped when the speed of the vehicle is approximately zero;
generating, in response, output based on the auto stop inhibit condition if the auto stop inhibit condition falls within a predetermined class of auto stop inhibit conditions; and
displaying or playing the output to inform the driver about the detected auto stop inhibit condition.

7. The method of claim 6 wherein the predetermined class of auto stop inhibit conditions includes climate system activated, entertainment system activated, steering wheel angle greater than threshold value, brake pedal disengaged, accelerator pedal engaged or power access point active.

8. The method of claim 6 wherein the output is indicative of a number of auto stop inhibit conditions detected during a drive cycle.

9. The method of claim 6 wherein the output is displayed via text.

10. The method of claim 6 wherein the output is displayed via a graphical interface element.

11. A vehicle comprising:
an engine;
a stop/start system configured to selectively auto stop and auto start the engine, to detect an auto stop inhibit condition that prevents the engine from being auto stopped, and in response, to generate output based on the auto stop inhibit condition if the auto stop inhibit condition falls within a predetermined class of auto stop inhibit conditions; and
an interface arranged to display or play the output.

12. The vehicle of claim 11 wherein the predetermined class of auto stop inhibit conditions includes climate system activated, entertainment system activated, steering wheel angle greater than threshold value, brake pedal disengaged, accelerator pedal engaged or power access point active.

13. The vehicle of claim 11 wherein the output is indicative of a number of auto stop inhibit conditions detected during a drive cycle.

14. The vehicle of claim 11 wherein the interface is configured to display the output via text.

15. The vehicle of claim 1 wherein the interface is configured to display the output via a graphical interface element.
